(19) United States
(12) Patent Application Publication
(10) Pub. No.: US 2022/0122078 A1
(43) Pub. Date: Apr. 21, 2022

(54) PERSONAL FINANCE SECURITY, CONTROL, AND MONITORING SOLUTION

(71) Applicant: Matthew Cherry, Gaithersburg, MD (US)

(72) Inventor: Matthew Cherry, Gaithersburg, MD (US)

(73) Assignee: Elegant Technical Solutions Inc., Gaithersburg, MD (US)

(21) Appl. No.: 17/507,354

(22) Filed: Oct. 21, 2021

Related U.S. Application Data
(60) Provisional application No. 63/094,536, filed on Oct. 21, 2020.

(51) Int. Cl. G06Q 20/40; G06Q 20/32; G06Q 40/02

(52) U.S. Cl. CPC G06Q 20/405; G06Q 40/02; G06Q 20/3224

(57) ABSTRACT

A safe, secure, short-term repository of transactional information collected across financial institutions and stored in a single place, specifically allowing safeguards to be created and executed across accounts is described so as to protect the financial accounts of a vulnerable user. A mobile device application facilitates near-real-time alerts, approvals, and potential geo-notifications available for instant action by Guard users. The system allows geographically distant loved ones the ability to Guard the financial transactions of a user from afar. Multi-account withdrawal and transaction safeguards may be implemented, treating multiple financial accounts as a single account as it pertains to an established and imposed multi-account withdrawal limit.

This application is a non-provisional application of provisional patent application No. 63/094,536, filed on Oct. 21, 2020, and priority is claimed thereto.

### FIELD OF THE PRESENT INVENTION

The present invention relates to the field of financial instruments tailored to the security of the account holder, and more specifically relates to a new form of financial security system equipped with an account monitoring and control mechanism configured to ensure the safe-keeping of the account owner's assets while enabling the permitted limited control of the account(s) by one or more trusted parties.

### BACKGROUND OF THE PRESENT INVENTION

In today's world, there is no shortage of people who prey on the vulnerable and attempt to manipulate them out of their money. Some are “legitimate” businesses and organizations trying to sell them something that they just don't need, and some are individuals convincing them to invest in some far-fetched scheme that's certainly not going to work. Others are scam and/or con artists deliberately lying and trying to slyly steal their money. Most people are savvy enough to recognize these interactions and avoid falling for such scams. Most people simply hang up the phone or delete the suspect email. However, certain members of our society—specifically seniors—are extremely susceptible and very frequently lose large sums of money to these nefarious enterprises. In many, if not most cases, they simply cannot afford to spare the loss.

Unfortunately, there are no effective safeguards in place today to help protect this vulnerable demographic. Seniors generally do not want to give up their independence, handing over total financial control to their children, even if they trust them. They might share a joint account—where the family can keep track of, and watch, their activity. But the trouble with this model is that, even if the family member is extremely diligent, the problem is not generally detected until after the money has been withdrawn, and by then it's too late. In many cases, as age takes its toll, you need to protect your loved ones from themselves. Many financial institutions offer “no liability” protection, but this does not cover the account holder from falling for a scam—knowingly giving someone money and acknowledging it afterwards. Indeed, protecting your loved ones while allowing them to maintain their dignity is extremely difficult to balance. They simply cannot be watched 24 hours a day.

Thus, there is a need for a new form of account monitoring and rule instantiation mechanism configured to ensure the continued security of a user's accounts automatically while enabling trusted, user-approved Guard users to help keep track of the user's account activity. Such a system preferably employs a mobile and web-based application configured to facilitate the implementation of customized rules relating to transactions, including multi-institution and multi-account transaction limits which account for all linked accounts of the user simultaneously. Such a system is preferably configured to enact a variety of security-minded rules, including those configured to limit withdrawals to a pre-set dollar amount as instantiated across all linked-accounts.

### SUMMARY OF THE PRESENT INVENTION

The present invention is a web and mobile-based application and system that works with financial institutions to facilitate the limiting, monitoring, and regulation of account transactions. The system is configured to function with one's family (or other trusted user-approved individuals) to help look out for those most susceptible to financial exploitation, such as senior citizens. Creating an account on the system of the present invention for a vulnerable person lets users guard against fraudulent and nefarious activity across different financial institutions for that individual. The system allows “Trusted Guards,” users approved by the vulnerable person, to passively monitor, influence, and react to ongoing transactions. Trusted parties can set easy-to-understand financial safeguards (effectively rules for permitting or denying transactions), such as setting payment limits which function across multiple financial institutions simultaneously. This prevents the user from issuing large payments from multiple accounts in a specified period of time.

Conversely, the system can also let a trusted party pre-authorize transactions and also receive alerts pertaining to transactions in near-real time. In essence, rather than constantly worrying and having to frequently log into a joint bank account to monitor a loved one's financial activity—only to learn too late that they've become a victim—the system of the present invention helps one to passively guard the transactions, allowing loved ones to continue on independently, but giving a trusted party the opportunity to step in to review when suspicious activity occurs—before they are victimized.

By default, use of the system of the present invention is voluntary. Much like the voluntary action of setting up a joint bank account with a trusted family member, the system of the present invention is intended to be an assistive tool and also to serve as a catalyst for important financial discussions between loved ones. The safety and security of the user's account is paramount. Guard users of the system never have any access to funds of the Charge user through the application of the present invention. In fact, they aren't even privy to view balances or account numbers within those financial accounts. The system simply provides safeguards for transaction verification. And since the entire setup is voluntary (except in special cases—i.e. Conservatorship accounts) the potentially-vulnerable person in question always has the ability to modify the people serving in their trusted roles, cease and desist Guard functionality, or even close out their account entirely, and therefore always have a path to accessing their own financial resources, regardless of any safeguards in place.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts an example screenshot of the platform of the system of the present invention, detailing the view of the platform as seen by a Guard user and listing recent activity highlights of actions taken and actions monitored by the platform of the present invention.

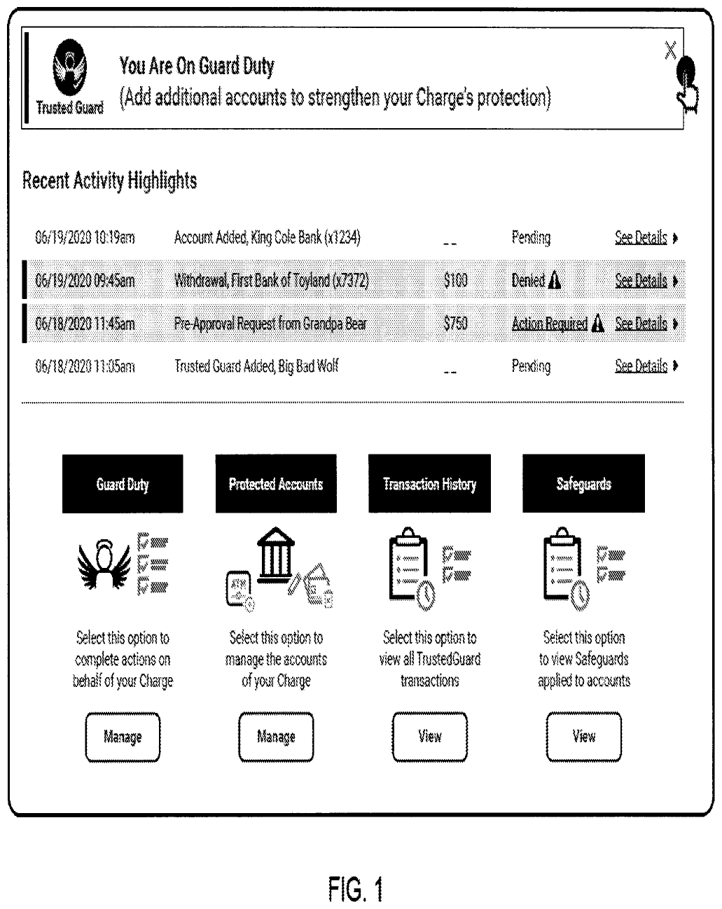

FIG. 2 shows a sample pre-approval request screenshot of the web-based application of the present invention as viewed by a Guard user.

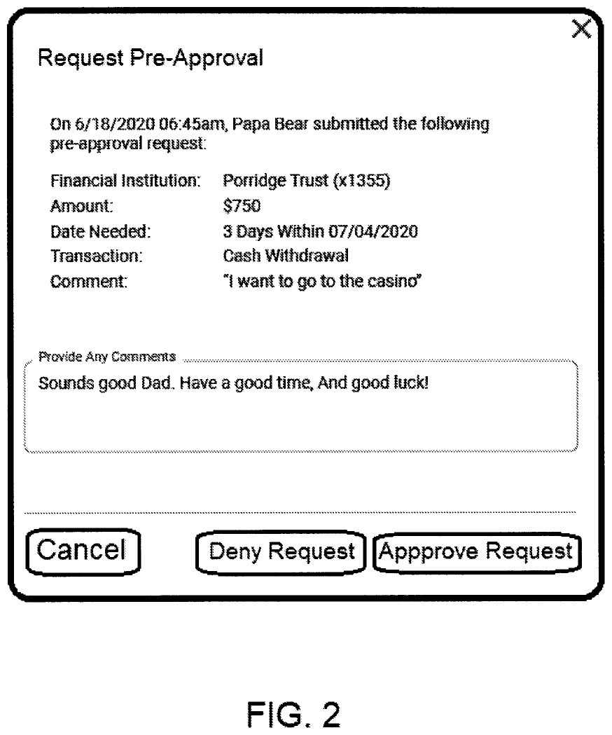

FIG. 3 shows a flow chart detailing the process of use of the present invention in the creation of a transaction rule for a reoccurring payment.

FIG. 4 depicts an example screenshot of the “Add New Safeguard” wizard of the platform of the system of the present invention, detailing the institution of a safeguard against an underlying financial account of the charge, limiting cash withdrawal to $100 per day.

FIG. 5 exhibits an example screenshot of listed safeguards applied to the underlying financial institution account(s) of the charge user.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is an integrated system and mobile device application (and web-based platform) for the monitoring and implementation of transaction-limiting rules configured to ensure the security of one or more financial accounts of a user as enacted by at least one user-approved Guard user. In practice, the present invention is an anti-theft, anti-scam, and anti-exploitation tool configured to maintain the safety and security of the assets of a vulnerable and/or elderly individual. It is voluntarily setup by at least two parties (individuals), with the intention of one party (referenced as a Guard) standing financial guard for the other (referenced as a Charge). It should be noted that a “self-guard” option is preferably available in which the account is self-imposed such that the user implements his or her own safeguards/rules. Benefits of the system and application of the present invention:

Helps to prevent financial fraud and exploitation.

Helps to protect loved ones from those who would do them financial harm.

Helps to protect loved ones from themselves through poor or compromised decisions.

Provides loved ones a safe and secure path to financial independence, allowing them to maintain their freedom and dignity.

Provides loved ones financial guidance, while ultimately keeping them in control of their own finances.

In contrast, the system of the present invention is not configured for:

Remote Banking—The system will not allow a user to pay bills, make deposits, transfer funds, view balances, etc.

Investing tool—The system will not report stock quotes, interest, allow trades, etc.

Financial Monitoring Tool—The system of the present invention does not maintain account balances, show statements, provide individual institution summaries, show trending charts, etc.

Roles:

The system of the present invention assigns two domain-specific roles, the ‘Guard’ and the ‘Charge’, and also third role—the account ‘Admin’, which can perform administrative duties. Further, a self-guard role may be instituted on the platform in which users guard themselves by setting up their own safeguards.

The Charge Role

The Charge is the vulnerable party (i.e.—a slightly compromised elderly person). This is the person who owns the accounts which the system aims to protect. It is their financial accounts that will be added to the system for financial guarding. In some embodiments of the present invention, multiple Charge users (i.e.—two elderly parents which have a ‘joint’ account) may be managed by the same Guard user(s) via the system and platform of the present invention. The Charge user has limited capability within the system once the account is created, however as it is their financial accounts in question, they are always ultimately in control. They assign and can change/delete their Guard users, as well as close the account entirely. The Charge user may perform the following actions:

1. Submit new financial institution account ‘add’/‘delete’ request (add/remove new bank account)

2. Submit new payee ‘add’/‘delete’ request (i.e. add a bill/vendor)

3. View transaction history

4. Invite new/additional Guard user

5. Assign account Administrators (pick a Guard user—can be included as part of the new Guard request)

6. Revoke Guard user privilege (the system generally requires at least one Guard)).

7. Close the account of the platform of the present invention (the underlying Financial Institution Accounts cannot be closed or even modified via the platform)

8. Issue a pre-approval request—a pre-approval request is conveyed to a guard user for approval of a transaction or withdrawal that is beyond the established guidelines.

The Guard Role

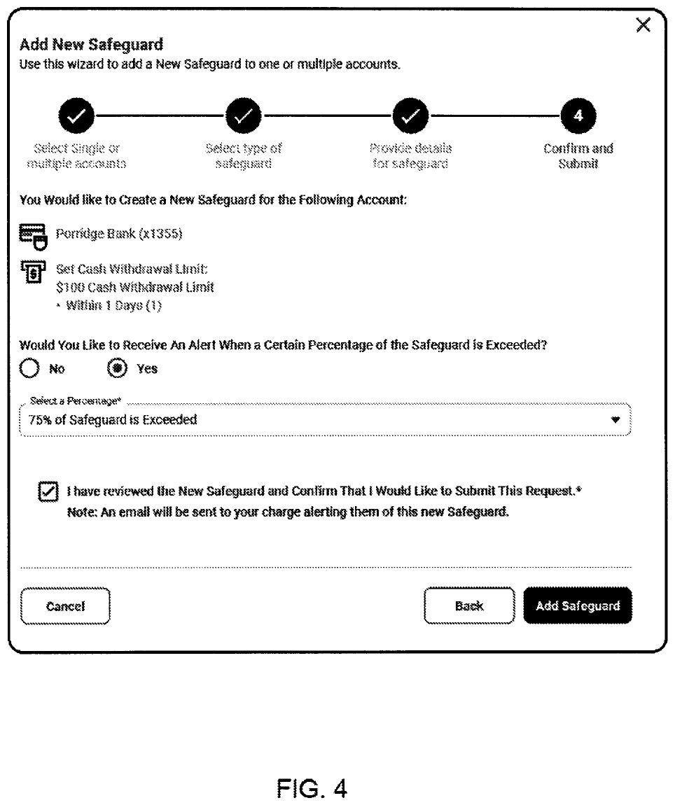

The Guard is a trusted party who is guarding the financial accounts. There may be more than one Guard for a single account (i.e.—two brothers both serve as Guard users to their father's account). The Guard user has the real responsibility as enabled by the mobile device application and/or web-based application of the platform. Ultimately, the Guard user has the ability to set safeguards surrounding the Charge user's financial accounts. It is presumed that the Guard user works with the Charge user to establish these safeguards so that the Charge user is not completely surprised when they hit, but those discussions occur outside the automation boundary of the system. However, the Charge is preferably notified via email as safeguards are set. An example screenshot of the safeguard adding wizard of the platform of the present invention can be seen in FIG. 4.

The Guard is permitted to perform the following actions via the application of the system of the present invention:

1. View transaction history

2. Set and manage Safeguards

3. Approve/Deny Transaction

4. Create Pre-approval

5. Receive Activity Alerts

6. Approve pre-approval requests

Note: Guard users have no access to account funds, account numbers, or balance information through the mobile device application or web-based application of the present invention. Guard users simply set up safeguards and rules to monitor the financial transactions of the Charge user. It should be noted that Guard users need not have an account at the various financial institutions to which the Charge user is a member.

The Admin Role

The Admin role is preferably granted to at least one Guard and provides the Guard user with the ability to submit accounts and suggest or initially setup Guard users on behalf of the Charger user. Ultimately, the Charge user must approve these suggested appointments. It is also possible that no guards are assigned the Admin role, and therefore the effective functionality of the Admin role is administered by the Charge user itself. The Admin user may also perform various administrative tasks, including submitting requests to the Charge user for additional Guard user accounts. It is not possible to be ‘just an Admin’. A user must be in the Guard (or charge) role to also effectively serve as an Admin. It should be noted that the Admin role is not assigned to the Charge user, rather the Charge user automatically has full administrative and account control within the system of the present invention. The Admin role permits a Guard User to Add/Remove requests to the Charge user for the following actions:

Add or Delete underlying financial institution account

Submit new payee ‘add’/‘delete’ request (i.e. add a bill/vendor)

Add/Delete a new Guard It should be understood that the execution of these actions generates request to the Charge user who may then approve or deny.

### Initial Account Creation

Prior to use of the system of the present invention, an account must be created. The account is initially created by either a Charge user or a Guard user, who then, during the process, invites the other party via email (if needed). In instances of “self-guard” use of the system and platform of the present invention, no invite of a second party is necessary. Once both parties have supplied their information, the account is ready for use. A Guard user may setup an account with the platform of the present invention, and indicate that he or she is opting to be a Guard user for a specific charge. The user would then enter the charge user's information, including his/her email address. Then, the system would convey the request to the charge user, prompting him/her to create an account to facilitate use of the platform, or in the event that the Charge user already has an account, the Guard user's request to be added would appear as a notification (email, pop-up, text, mobile device notification, etc.) to the Charge user.

### Adding Financial Institutions to the Account

Both Guard users (equipped with the Admin role) and Charge users may submit external financial institution accounts to the account, but only a Charge user can approve them to be officially added to account. The financial institution accounts must be equipped with backend software configured to interface with the platform of the present invention to facilitate the communication between the financial institution account and the account of the present invention. If the Charge user adds a financial institution account, the account is automatically added to the system.

### Creating Transaction and Withdrawal Rules (Safeguards)

Safeguarding is the entire basis of the system of the present invention and is the responsibility of the Guard users to create and ensure their proper functionality. There are several mechanisms through which this can be accomplished:

Setting Safeguards

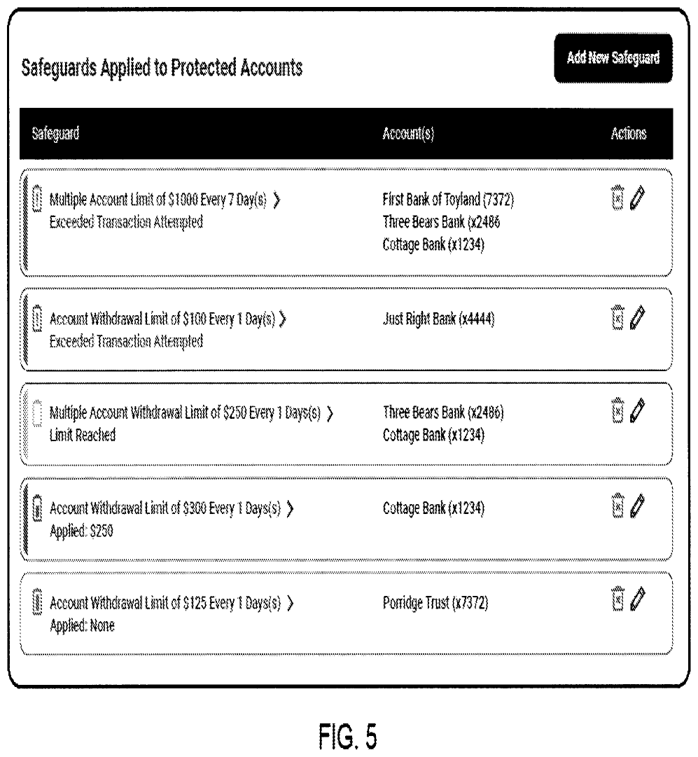

Safeguards are basically rules set against the Charge user's financial accounts. Rules can be against an individual financial account (i.e.—do not allow the Charge user to withdraw more than $100 in a day from “Bank A”), or across multiple financial accounts (i.e.—do not allow the Charge user to withdraw more than $100 across all bank accounts in a day). They can be customized by amounts ($100) and time (day/week/month). Additionally, they can be customized by “number of days,” (for example, 1 day, 7 days, 30 days). Verified bills/vendors can be pre-approved for autopay up to certain amounts (just like at a bank). Every time a safeguard is created, the Charge user is alerted electronically (i.e. via email) with its details. An example of safeguards instituted on the financial institution account(s) of a charge user may be seen in FIG. 5. From this screen, safeguards may be added, edited, or removed.

### Approve/Deny Transactions

In some cases, financial transactions conducted by the Charge user may be approved manually (i.e.—check writing or ACH withdrawal). In cases where this has been configured and is applicable, the normal financial process is interrupted pending an approval from a Guard user. For example, if a Charge user were to write a check that exceeded a safeguard or did not have pre-approval, before the check were to clear it would be subject to approval/denial from a Guard user. When configuring said safeguards, a default action would be identified as to what to do if a certain period of time passed without action (i.e.—if a check comes through and isn't approved in 24 hours, automatically approve the transaction).

### Creating Pre-approvals

In certain cases, it might be possible to know a Charge user is intending on spending a certain amount of money that exceeds the safeguards in place, however it is not known exactly when it will occur. For example, the charge may inform the Guard user that a repair man is supposed to come to the house this week to repair an air conditioning unit. A Guard may ‘preauthorize’ up to a pre-established amount, either to a specific vendor or in a ‘Generic’ category. Using a Pre-approval allows a transaction to proceed successfully even though it may exceed any set Safeguards. In such instances, a ‘payee’ is preferably established; however, the system of the present invention is not configured to interface directly with payees/vendors. More commonly, pre-approvals may be effected for withdrawals from a specific underlying financial institution for a given amount or range of amounts.

### Receiving Activity Alerts

The system is configured to send near-real-time alerts to the Guard users when certain safeguards are challenged such as: attempting a cash withdrawal beyond set threshold from one or more accounts, issuing a payment over a threshold amount, or other defined criteria. Preferably, these alerts are enabled by default, and are issued when any safeguard is exceeded. Eventually, the system preferably allows Guard users to set specific geographic locations so they could receive notifications if the Charge user(s) were to approach a financial institution, which could then prompt a courtesy call (outside of automation boundary) just to check in on what's going on.

### Financial Transaction Flow

The system of the present invention works in tandem with the external financial institutions to which the Charge user maintains accounts in order to help ensure the security of the Charge user. Safeguards (transaction/withdrawal rules) are setup within the system and financial institutions offer the service of the present invention as facilitated via the platform to their customers via backend API integration.

Once enrolled, financial institutions incorporate a “Check” into their transaction process which is configured to communicate with at least one server computer and/or database of the system of the present invention. If the check passes, the transaction proceeds as intended. If the check fails, the transaction is denied, logged, and notifies the Charge user and all Guard users why it failed. A descriptive failure message is also returned and optionally presented by the financial institution. The check effectively compares the safeguards implemented via the mobile device and/or web-based application by the Guard user to the proposed transaction at hand in real-time.

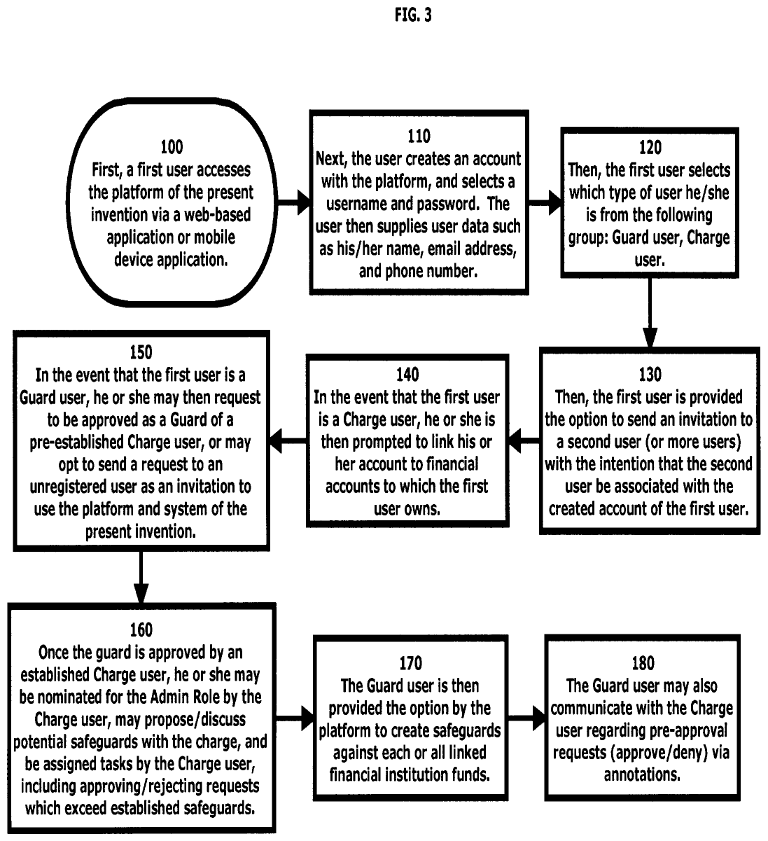

The base process of account creation and use of the system and apparatus of the present invention, as shown in FIG. 3, is preferably as follows:

1. First, a first user accesses the platform of the present invention via a web-based application or mobile device application. (100). The web-based application is preferably accessed via an Internet browser, and the mobile device application is available via download on multiple platforms, including, but not limited to: Google™ Android™ Play Store™ and Apple™ App Store.

2. Next, the user creates an account with the platform, and selects a username and password. The user then supplies user data such as his/her name, email address, and phone number. (110)

3. Then, the first user selects which type of user he/she is from the following group: Guard user, Charge user. (120)

4. Then, the first user is provided the option to send an invitation to a second user (or more users) with the intention that the second user be associated with the created account of the first user. (130)

5. In the event that the first user is a Charge user, he or she is then prompted to link his or her account to financial accounts to which the first user owns. (140)

6. In the event that the first user is a Guard user, he or she may then request to be approved as a Guard of a pre-established Charge user, or may opt to send a request to an unregistered user as an invitation to use the platform and system of the present invention. (150)

7. Once the guard is approved by an established Charge user, he or she may be nominated for the Admin Role by the Charge user, may propose/discuss potential safeguards with the charge, and be assigned tasks by the Charge user, including approving/rejecting requests which exceed established safeguards. (160).

8. The Guard user is then provided the option by the platform to create safeguards against each, some, or all linked financial institution funds (or accounts). (170)

9. The Guard user may also communicate with the Charge user regarding pre-approval requests (approve/deny) via annotations. (180)

It should be understood that the platform of the present invention, both the web-based application and the mobile device application, are additionally configured to facilitate communication between the charge user(s) and guard user(s) pertaining to personal finances, including, but not limited to: annotated messages pertaining to requests for transaction approval, pre-approval requests front the Charge user(s), pre-approval responses from the Guard user(s), and general discussion pertaining to financial dealings with one or more of the accounts of the Charge user(s). Such communication is preferably readily available and accessible to users within the platform via one or more graphical UI elements (i.e. a requests notification, a messaging feature of the application, or a similar tab, link, or button per conventional digital navigation mechanisms).

Furthermore, it should be noted that both platform embodiments of the platform and system of the present invention are equipped to facilitate connection to assorted external financial institutions (banks, fund management companies, credit agencies, and similar conventional financial institutions), individual account owners of the assorted external financial institutions (charge users), and trusted individuals (guard users) aiming to safeguard the finances of the Charge user. The system of the present invention is easy to setup, either by the charge user and/or guard user as there is no requirement to physically visit a bank and wait to see an account manager. Establishing accounts for use of the system and platform of the present invention is easy and quick to perform via either the web-based platform or mobile device application of the system. Additionally, it should be noted that the present invention is an inherently secure system, as guard users are never formally associated with the underlying financial account(s), and therefore are not permitted access to pertinent account data.

Finally, it should be understood that while Charge users are not effectively equipped with the Admin role, they are automatically granted all rights and privileges of a user with the Admin role, and maintain the ultimate authority over their own account(s).

In some embodiments of the present invention, charge users may facilitate a “view-only” access option to guard users. Via the “view-only” access option, guard users may only be alerted to transactions, but are not afforded the capacity to approve or deny the transaction prior to processing. The “view-only” access option is designed to afford guard users insight into the financial comings and goings of the charge to see if there is anything suspicious with the transactions. If seemingly suspicious transactions arise, the guard user may then have a conversation with the charge user to ensure that the suspicious transactions were authorized and purposeful. Guard users granted the “view-only” access option may receive push notifications and/or SMS text notifications to indicate when, where, and for how much the transactions are conducted, but the guard user may not affect the process of the transaction in any way without being granted additional permissions. Effectively, the “view-only” option enables any designated view-only user to simply log into the platform of the present invention and view the safeguards in place, as well as to view the transactions that have been enacted for the designated charge. Additionally, users granted “view-only” access can view all of the same information about the charge user (accounts, safeguards in place, guard users, transactions, and other data) but are afforded non edit/action permissions. “View-only” access users may not create or remove safeguards.

Further, it should be noted that the platform of the present invention preferably enables the charge user and/or admin user to grant a guard user the ability to know, via geolocation data provided by the mobile device of the charge user, when the charge user enters the proximity of a known bank or financial institution to which the charge user has an account. Geolocation data is preferably provided via cell phone tower triangulation, WiFi triangulation, and/or onboard GPS data. This feature must be permitted by the charge user via their mobile device.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method of asserting guardianship over the finances of a charge user by at least one guard user via an online platform accessed on an internet-connected device comprising:
the at least one guard user navigating to the platform on the internet-connected device, the guard user being an approved custodian of the charge user;
the charge user creating an account on the platform;
the at least one guard user creating an account on the platform;
the at least one guard user, with permission of the charge user, linking his account with the account of the charge user;
the at least one guard user interfacing the platform with financial institutions associated with the charge user on behalf of the charge user;
the platform communicating with the financial institutions to monitor financial activity;
the platform providing the guard user the option to send an invitation to a second guard user with the intention that the second guard user be associated with the created account on the platform;
the charge user nominating an admin from the at least one guard user;
the charge user discussing safeguards with the at least one guard user, the safeguards selected from the following group: approving financial transactions, denying financial transactions, approving cash withdrawals, denying cash withdrawals, and establishing thresholds for transactions and withdrawals, the thresholds, when exceeded, triggering notification of the attempt to access funds in excess of the threshold, thereby prompting an approval or denial from at least one guard user; and
the at least one guard user instituting the discussed safeguards on the platform.

2. The method of claim 1, further comprising:
the charge user attempting a financial transaction of funds from a financial institution linked to the platform;
the platform evaluating if the financial transaction attempt is below an established threshold safeguard as imposed by the at least one guard user;
the platform permitting the financial transaction if the request is within the established threshold;
the platform notifying at least one guard user of the financial transaction attempt via a notification on an internet connected device disposed in communication with the platform if the financial transaction attempt is greater than the established threshold; and
the platform denying the financial transaction if the request is greater than the established threshold and if the at least one guard user fails to manually approve the financial transaction attempt per the notification.

3. The method of claim 2, wherein the financial transaction attempt is an account debit.

4. The method of claim 2, wherein the financial transaction attempt is a purchase.

5. The method of claim 2, wherein the financial transaction attempt is a withdrawal from a retirement account.

6. The method of claim 2, wherein the established threshold safeguard is a multi-account safeguard, preventing the charge user from surpassing the established threshold across a combination of designated accounts cumulatively.

7. The method of claim 1, wherein the charge user is the owner of the financial accounts; and
wherein the guard user is the owner of the financial accounts, facilitating a self-guard option via the platform.

8. The method of claim 2, wherein the charge user is the owner of the financial accounts; and
wherein the guard user is the owner of the financial accounts, facilitating a self-guard option via the platform.

9. The method of claim 1, further comprising:
the platform monitoring the location of the charge user via geolocation data provided by the mobile device of the charge user; and
the platform alerting the guard user when the charge user comes within a defined proximity of a financial institution to which the charge user has an account.
